(19) United States
(12) Patent Application Publication
(10) Pub. No.: US 2016/0303909 A1
(43) Pub. Date: Oct. 20, 2016

(54) Safety tire having compartments

(71) Applicant: Dave Wang, Taipei (TW)

(72) Inventor: Dave Wang, Taipei (TW)

(21) Appl. No.: 15/193,137

(22) Filed: Jun. 27, 2016

(30) Foreign Application Priority Data
May 16, 2016 (TW) 105115013

(51) Int. Cl. B60C 5/24; B60C 19/12; B60C 17/06; B60C 17/01

(52) U.S. Cl. CPC B60C 5/24; B60C 17/01; B60C 19/127; B60C 17/06; B60C 2019/005

(57) ABSTRACT

A safety tire in combination with a rim includes an outer tube; a reinforcing layer secured to the outer tube; and a plurality of partitions for dividing a space formed by the reinforcing layer, the outer tube, and the rim into a plurality of compartments. Each compartment is implemented as an inner tube unit and includes a cavity in a first end, the cavity having a first magnetic element on a bottom, and a protuberance on a second end, the protuberance having a second magnetic element on an open end, the protuberance being releasably fastened in the cavity of an adjacent compartment by attaching the second magnetic element to the first magnetic element of the adjacent compartment. Each partition includes a central tunnel put on the protuberance, and corrugations adjacent to the central tunnel.

### BACKGROUND OF THE INVENTION

1. Field of the Invention

The invention relates to safety tires and more particularly to a safety tire having connected compartments so that a vehicle incorporating the tires can run normally even when a small number of the compartments are punctured.

2. Description of Related Art

A blowout of a conventional vehicle tire at high speed can cause a vehicle to go out of control and even cause injury or death. In order to minimize the dangers in the event of a tire blowout, various proposals have been patented to prevent tire deflation.

While some of the patents enjoy its success in the market, continuing improvements in the exploitation of safety tire are constantly being sought.

### SUMMARY OF THE INVENTION

It is therefore one object of the invention to provide a safety tire in combination with a rim comprising an outer tube; a reinforcing layer secured to the outer tube; and a plurality of partitions for dividing a space formed by the reinforcing layer, the outer tube, and the rim into a plurality of compartments.

The above and other objects, features and advantages of the invention will become apparent from the following detailed description taken with the accompanying drawings.

### BRIEF DESCRIPTION OF THE DRAWINGS

FIG. 1 is an exploded view of a unit of a safety tire according to a first preferred embodiment of the invention;

FIG. 2 is a longitudinal sectional view of the assembled unit of the tire and the rim;

FIG. 3 is a view similar to FIG. 2 with the partition added;

FIG. 4 is a longitudinal sectional, side elevational view of the tire and the rim;

FIG. 4A is a view similar to FIG. 4 showing the annular space being divided into compartments by the partitions;

FIG. 5 is a fragmentary view of FIG. 4A;

FIG. 6 an exploded view of a unit of a safety tire according to a second preferred embodiment of the invention;

FIG. 7 is a longitudinal sectional view of the assembled unit of the tire of FIG. 6, and the rim; and

FIG. 8 is a fragmentary, longitudinal sectional view of an upper portion of the tire and the rim of FIG. 7.

### DETAILED DESCRIPTION OF THE INVENTION

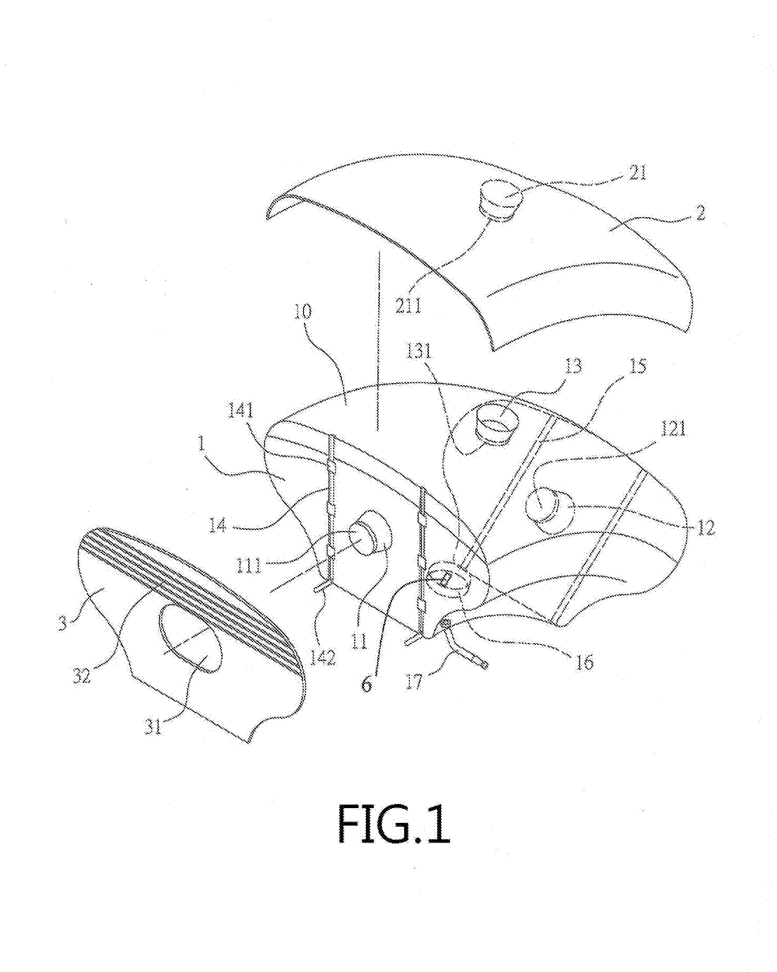

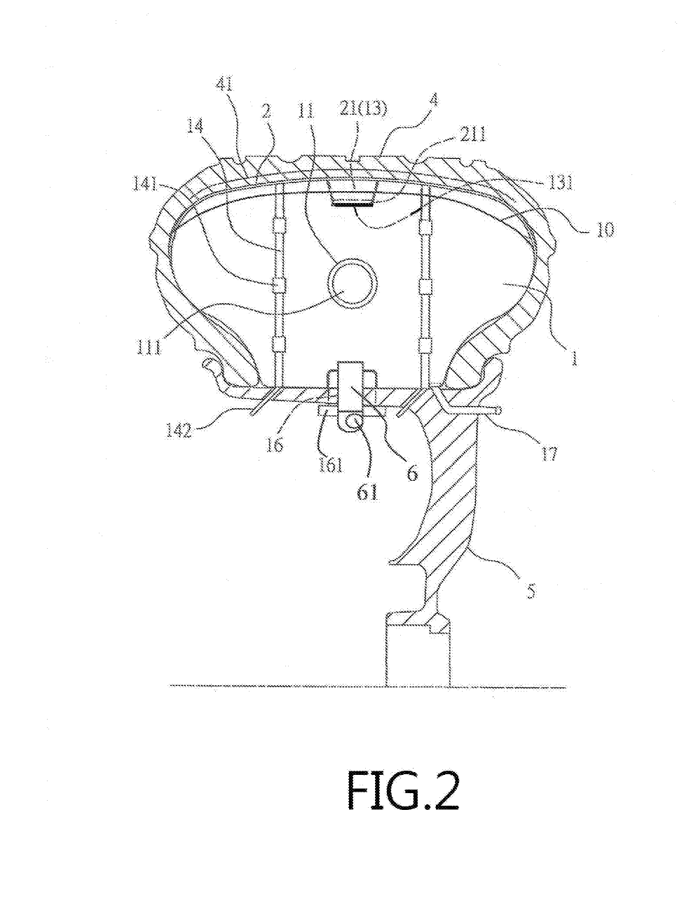

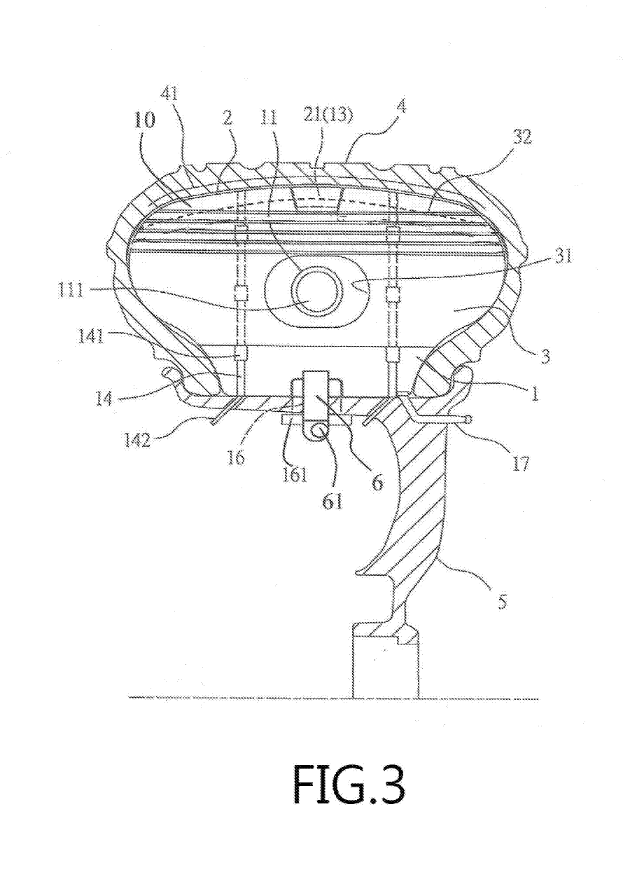

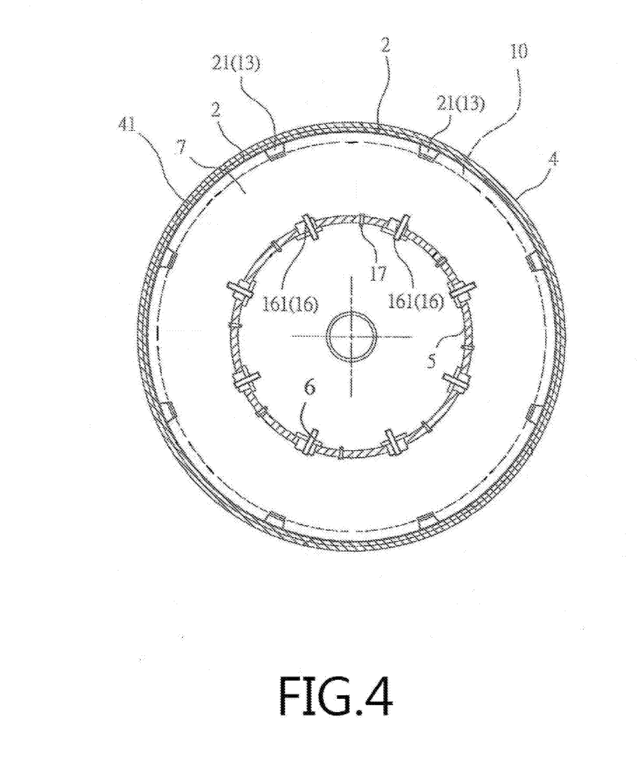

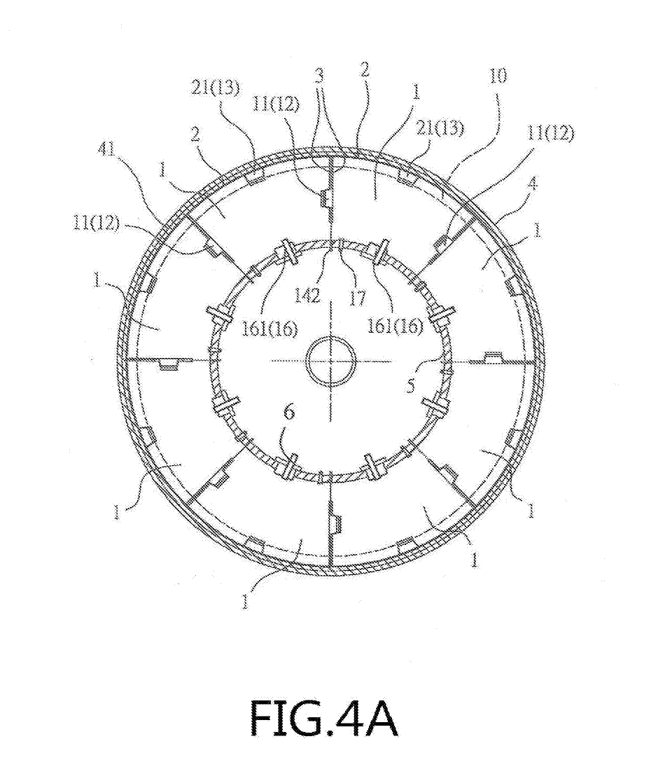

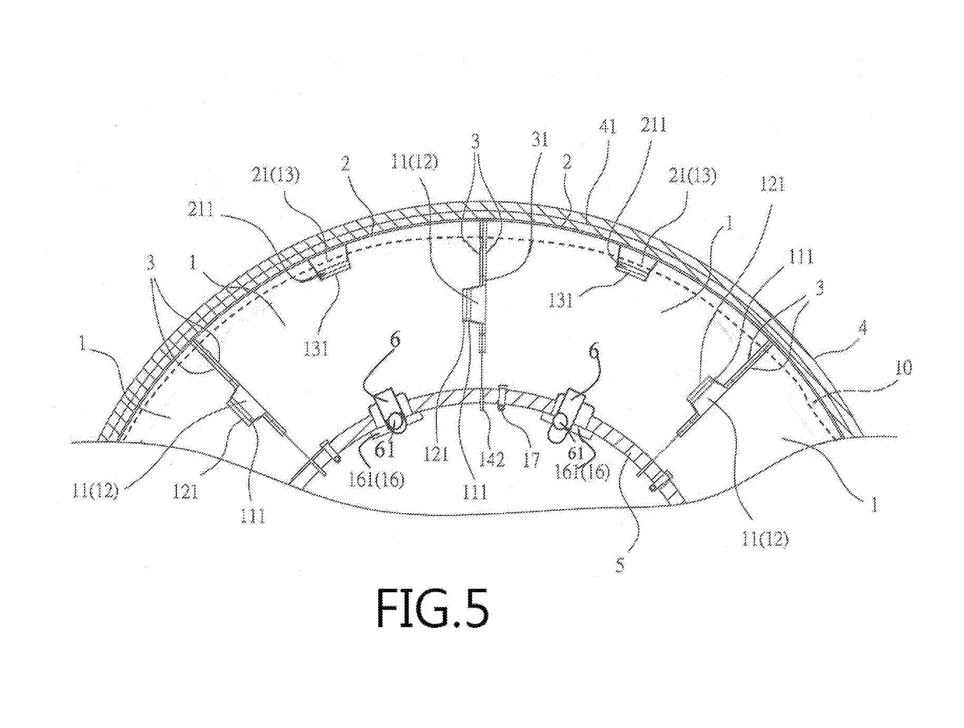

Referring to FIGS. 1 to 5, a safety tire in accordance with a first preferred embodiment of the invention comprises an outer tube 4 including a puncture resistant member 41 secured to an inner surface of the outer tube 4 and made of light metal, alloy, ceramic, or fiber-reinforced plastic (FRP); a padding layer 2 secured to an inner surface of the puncture resistant member 41 and including a projection 21 projecting downward, the projection 21 having a magnetic member 211 on an open end; a reinforcing layer 10 secured to an inner surface of the padding layer 2 and including a radial through hole 13 having a magnetic unit 131 on an inner end wherein the projection 21 is releasably fastened in the radial through hole 13 by attaching the magnetic member 211 to the magnetic unit 131; a plurality of partitions 3 for dividing an annular space 7 formed by the reinforcing layer 10, the outer tube 4, and a rim 5 into a plurality of compartments 1, each compartment 1 implemented as an inner tube unit and including a cavity 12 in a first end, the cavity 12 having a first magnetic element 121 on a bottom, and a protuberance 11 on a second end, the protuberance 11 having a second magnetic element 111 on an open end, the protuberance 11 complimentarily fastened in the cavity 12 of an adjacent compartment 1 to have the second magnetic element 111 attached to the first magnetic element 121 so that two adjacent compartments 1 can be secured together, two first channels 14 provided through the second end of the compartment 1 and the reinforcing layer 10 and each having a plurality of spaced support enlargements 141 and an outlet 142 at one end for communicating with the external, two second channels 15 provided through the first end of the compartment 1 and the reinforcing layer 10 and each being a mirror image of the first channel 14, a hollow threaded shank 16 through the rim 5, and a nut 161 threadedly secured to the hollow threaded shank 16 to fasten the rim 5 and the compartment 1 together; a plurality of transparent tubes 6 each disposed in the hollow threaded shank 16; a float member 61 confined in the transparent tube 6 and configured to move in the transparent tube 6 in response to variation of pressure in the compartment 1; and a plurality of valves 17 each having one end terminated in the compartment 1 and the other end projecting out of the outer tuber 4, the compartment 1 being configured to fill with pressurized air through the valve 17. The partition 3 includes a central tunnel 31 put on the protuberance 11, and a plurality of parallel resilient corrugations 32 adjacent to the central tunnel 31.

Air between the outer tube 4 and the padding layer 2 can be squeezed out of the tire by passing through the outlets 142 when a vehicle equipped with the tires of the invention runs on a road, i.e., relieving pressure. Otherwise, the tire may explode. Moreover, the corrugations 32 can be compressed to absorb and damp shock impulses. Otherwise, the partitions 3 may be damaged. One or more compartments 1 may lose air due to puncture(s) through the outer tube 4, the padding layer 2, and the reinforcing layer 10. Advantageously, the vehicle incorporating the tires can still run normally because the air leaking is confined to the compartments 1 being punctured.

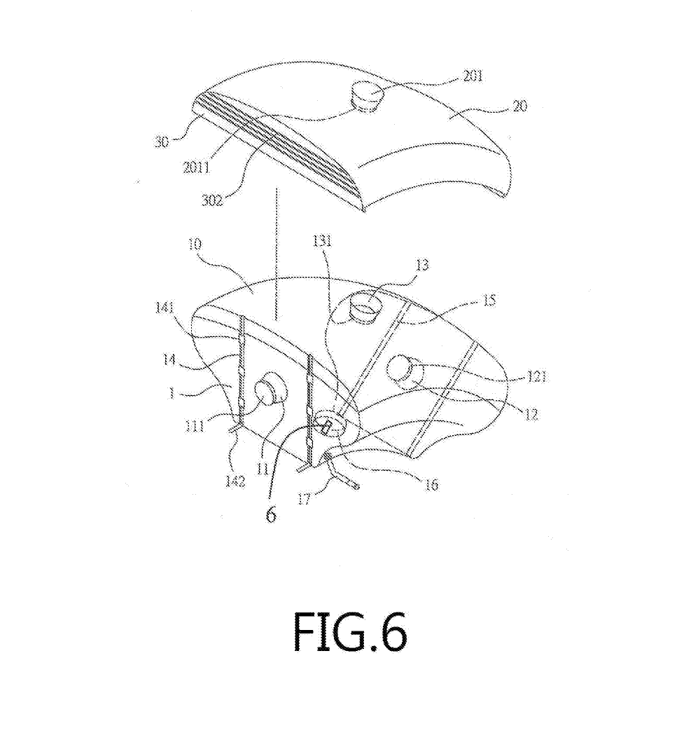

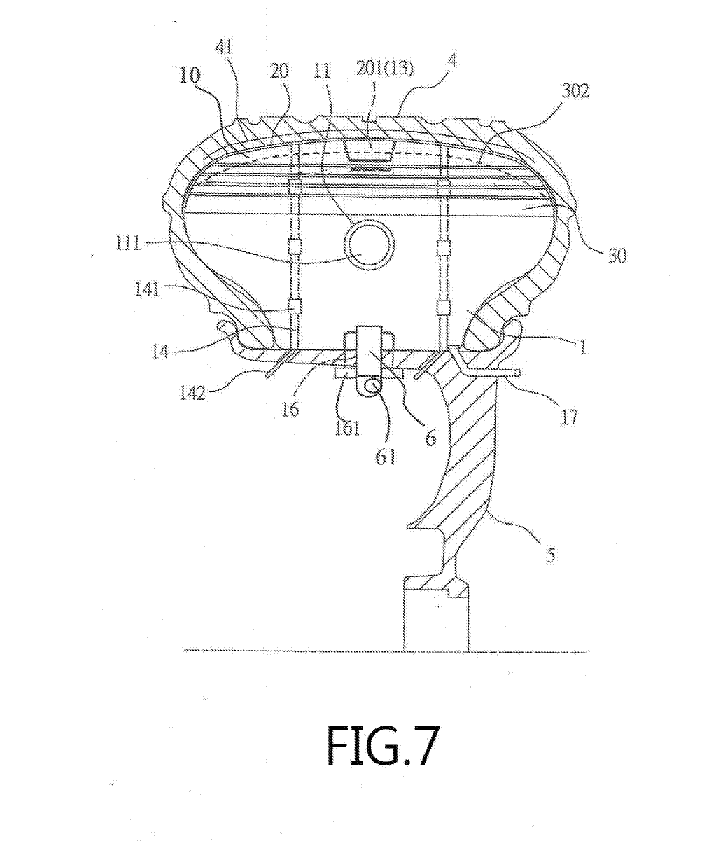

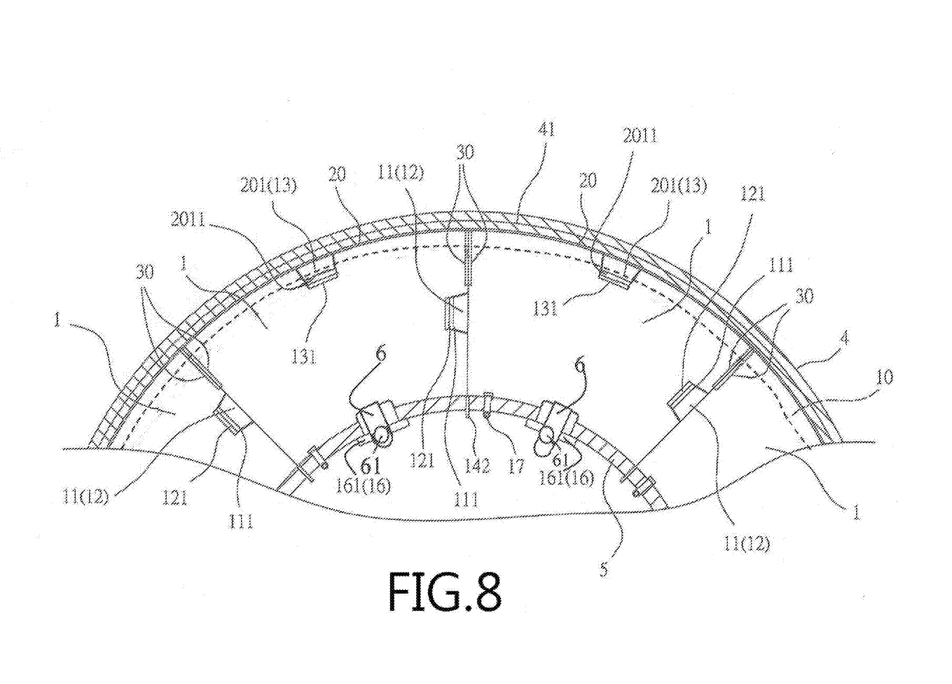

Referring to FIGS. 6 to 8, a safety tire in accordance with a second preferred embodiment of the invention is shown. The characteristics of the second preferred embodiment are substantially the same as that of the first preferred embodiment except the following:

The partitions 30 are formed integrally with an end of the padding layer 20. The partition 30 is provided between the padding layer 20 and the protuberance 11. The partitions 30 do not have a central tunnel put on the protuberance 11.

While the invention has been described in terms of preferred embodiments, those skilled in the art will recognize that the invention can be practiced with modifications within the spirit and scope of the appended claims.

What is claimed is:

1. A safety tire in combination with a rim comprising:
an outer tube;
a reinforcing layer secured to the outer tube; and
a plurality of partitions for dividing a space formed by the reinforcing layer, the outer tube, and the rim into a plurality of compartments.

2. The safety tire of claim 1, wherein each compartment is implemented as an inner tube unit and includes a cavity in a first end, the cavity having a first magnetic element on a bottom, and a protuberance on a second end, the protuberance having a second magnetic element on an open end, the protuberance being releasably fastened in the cavity of an adjacent compartment by attaching the second magnetic element to the first magnetic element of the adjacent compartment; and wherein each partition includes a central tunnel put on the protuberance, and a plurality of resilient corrugations adjacent to the central tunnel.

3. The safety tire of claim 1, wherein the outer tube includes a puncture resistant member on an inner surface.

4. The safety tire of claim 3, further comprising a padding layer fastened between the puncture resistant member and the reinforcing layer, the padding layer including a projection having a magnetic member on an open end.

5. The safety tire of claim 4, wherein the reinforcing layer includes a radial through hole having a magnetic unit on an inner end, and wherein the projection is releasably fastened in the radial through hole by attaching the magnetic member to the magnetic unit.

6. The safety tire of claim 2, wherein each compartment further comprises a threaded shank through the rim, and a nut threadedly secured to the threaded shank to fasten the rim and the compartment together.

7. The safety tire of claim 2, wherein each compartment further comprises a plurality of channels disposed through the reinforcing layer and the first and second ends of the compartment, each channel including a plurality of spaced support enlargements and an outlet at one end.

8. The safety tire of claim 2, wherein each compartment further comprises a valve having one end terminated in the compartment and the other end projecting out of the outer tuber.
